(19) United States
(12) Patent Application Publication
(10) Pub. No.: US 2009/0298374 A1
(43) Pub. Date: Dec. 3, 2009

(54) Acoustic Composite and Twin-Shell Lightweight Trim Part Comprising Such a Composite

(76) Inventor: Bertrand Delmas, Mantes la Jolie (FR)

Correspondence Address: DORITY & MANNING, P.A., POST OFFICE BOX 1449, GREENVILLE, SC, 29602-1449, US

(21) Appl. No.: 12/297,814

(22) PCT Filed: Apr. 23, 2007
(86) PCT No.: PCT/EP07/03538

§ 371 Date: Apr. 6, 2009

(30) Foreign Application Priority Data
Apr. 21, 2006 (EP) 06008354.0

(51) Int. Cl. B32B 5/24; B32B 3/26; B32B 7/08; B60R 13/08

(52) U.S. Cl. 442/374; 428/304.4; 428/316.6

(57) ABSTRACT

A twin-shell lightweight acoustic trim part (11), in particular a self-supporting vehicle's headliner or a rear parcel shelf comprises a thermoplastic acoustically effective structural composite (5). This composite comprises at least three layers (2, 3, 4), in particular on its front side a skin layer (4), preferably a binder layer made of a thermoplastic non-woven or grid, a stiffening layer (3) made of a non-woven comprising polypropylene and glass fibres, and on its rear side a soft layer (2) consisting of a polyolefin foam. These layers are needle-punched together in order to set a desired airflow resistance R in the range of 200 Nsm⁻³ to 5000 Nsm⁻³. In a preferred embodiment, the twin-shell lightweight acoustic trim part (11) comprises a core layer (8) which contains 50 parts of elastomeric foam sticks, 20 parts of glass fibres, 10 parts of polypropylene fibres material, and 20 parts bicomponent polyester fibres and preferably comprises additional 15% of recycled elastic foam material. This trim part is designed such that the thermoplastic bonded and acoustically effective structural composite (5) allows to absorb the uneven pressure forces of the elastomeric foam material (9) of the core layer (8) in order to achieve a smooth and soft touch feeling.

### FIELD OF THE INVENTION

The present invention relates to an acoustic composite, and a twin-shell lightweight acoustic trim part comprising such a composite.

Recyclable and lightweight multilayer trim-parts are well known in the art, for instance as disclosed in U.S. Pat. No. 5,976,295. This document reveals a component such as a headliner or sun visor for the interior of automotive vehicles, which component comprises a multilayer composite of polyester (PET) finishing fabric, a resilient layer of bicomponent polyester fibre padding and a relatively stiff core layer of polyester/glass fibres. These layers are consolidated and molded under heat and pressure into a lightweight, dense, and structurally strong composite. Of course, such a trim part is not suitable to substantially absorb acoustic energy, and feels stiff to the touch.

A typical twin-sheet vehicle headliner is disclosed in WO 2004/089592. This documents describes a process for thermoforming such a part by using two sheets of SuperLight material, whereby in a first step a first sheet is formed in a mold applying vacuum to the lower mold part, and whereby in a second step a second sheet is formed in the same mould applying vacuum to the upper mould part and whereby in a third step both parts are unified, i.e. sealed together and then cut along the desired shape. Such a twin-sheet headliner is lightweight and at the same time is stable enough to be used as a self-supporting headliner. Unfortunately, this twin-sheet headliner has a poor efficiency to absorb acoustic energy, since the separate sheets are airtight and rigid. In addition, the rigidity of the sheet on the passenger side generates an unpleasant haptic feeling.

EP-0 908 303 proposes to use a fibrous batt, which is sandwiched between two fibrous mats in order to create a recyclable and biodegradable vehicle panel such as a headliner. Unfortunately, this headliner either comprises rigid outer layers that give an unpleasant haptic effect and/or is not fulfilling class 3 requirements for the acoustic performance of headliners. In addition, this vehicle panel is compression molded and difficult to manufacture due to the multitude of fibre treatment steps.

A method of making a lightweight fibrous headliner with high elasticity is disclosed in U.S. Pat. No. 5,591,289. This headliner comprises a fibrous core with a cover on its front or passenger side providing an aesthetically pleasing surface and a scrim on its back or roof side providing reinforcement. The batting is needled on both sides to form integral skin layers of fibres, and then sandwiched by a scrim at its roof side and by a cover at its passenger compartment side before being placed in a heated compression mould. Unfortunately, this method does not allow for properly tuning the acoustic properties of such fibrous headliners. In addition, the cover at the passenger side feels stiff to the touch since it is bonded to a densified skin layer. Furthermore, the compression molding process does not allow for manufacturing thick parts, i.e. parts having a thickness of 2.5 cm to 8.0 cm.

The above makes evident that the known multilayer components for headliners or other self-supporting interior panels have poor acoustic characteristics and/or exhibit an unpleasant haptic effect and/or are complex and/or time-consuming, i.e. expensive to manufacture.

### SUMMARY

It is therefore an object of present invention to achieve a light weight, recyclable and self-supporting trim-part, in particular a headliner or a rear parcel shelf, which is fulfilling the acoustic requirements of class 3 or even class 4 specifications (according to the testing method PSA-Peugeot Citroen D45-5430), which provides a pleasant haptic effect, i.e. having a smooth and soft touch feeling, and which is economically to manufacture. Additional objects and advantages of the invention are set forth in part in the following description, or may be obvious from the description, or may be learned through practice of the invention.

The objects are achieved by a self-supporting twin-shell lightweight acoustic trim part comprising a thermoplastic bonded and acoustically effective structural composite.

This thermoplastic acoustically effective composite is suitable for manufacturing a self-supporting twin-shell lightweight acoustic trim part, in particular a headliner or a rear parcel shelf. This composite comprises on its front side a skin layer, preferably a binder layer made of a thermoplastic non-woven or grid, a stiffening layer, and on its rear side a soft layer, which layers are needle-punched together in order to set a desired airflow resistance in the range of 200-5000 Nsm′3. Preferably, this composite comprises a layer of PP-non-woven or thermoplastic grid (25 g/m2)+a layer of glass fibre reinforced PP-nonwoven (45% PP/55% GF, 150-250 g/m2, preferably 175 g/m2)+a layer of PO-foam (30-deltaOkg/m3, 1-3 mm, preferably 33 kg/m3, 3 mm). This composite performs as an acoustically effective element allowing setting the AFR-value (air-flow-resistance) in order to achieve the required acoustic performance by setting a suitable and preselected needling density or characteristics. The polyolefin foam is at initial conditions completely closed celled, i.e. completely airtight. After the needling process, this elastic polyolefin foam layer stays air permeable. Some of the glass fibres of the stiffening layer may be introduced in the punched holes during the needling process and help to keep these holes open.

The twin-shell lightweight acoustic trim part in accordance with the invention comprises such a thermoplastic acoustically effective structural composite and may further comprise an air-permeable cover layer, in particular a facecloth, a malifleece or a needle felt or a back foamed textile on its front or visible face on its passenger compartment side. The trim part further comprises a multi-layer skin structure on its back face, which is substantially impermeable and a core layer between the thermoplastic acoustically effective structural composite and the multi-layer skin structure, which core layer comprises elastomeric, i.e. resilient, foam material and/or fibre-felt material, preferably a blend of foam sticks or chips and fibre material. Since it is beneficial for the vacuum forming process to use for the core layer elastomeric, i.e. resilient, foam material, in particular foam sticks or chips with enhanced spring force, the visible side of the composite tends to form a rough-textured or rippled surface. The present invention allows for use for the composite's soft layer a foam material with a reduced spring force, in order to achieve the desired haptic properties. This selection allows to even the unevenness of the core's surface and provides for a smooth and soft touch feeling.

The twin-shell lightweight acoustic trim part in accordance with the invention may be manufactured by a vacuum forming process, i.e. by a simple and cost-saving method. In particular, the elastomeric material of the core layer assists the vacuum forming process. This trim part is completely recyclable, exhibits a high and tuneable acoustic performance, is self-supporting and has pleasant haptic properties, i.e. has a smooth and soft touch feeling. This trim part allows saving material costs by using foam that is recovered from scraps of the production, or from waste of cuts, or from vehicles out of use. Furthermore, the acoustic absorption may be increased by the use of open-pored foam sticks being part of the core layer.

These and other objects, advantages, and features of the present invention will become more apparent from the following description and accompanying drawings, wherein:

### BRIEF DESCRIPTION OF THE DRAWINGS

FIG. 1: shows a schematic cross-section through an acoustically effective composite according to the invention;

FIG. 2: shows a schematic cross-section through a trim part comprising such an acoustically effective composite;

FIG. 3: shows a schematic cross-section through the trim part according to FIG. 2 in more detail;

FIG. 4: shows a diagram related to the acoustic properties of a trim part in accordance with the invention.

The following references are used to indicate the relevant features of the invention:
1: structural thermoplastic bonded and acoustically effective composite
2: soft layer made of a polyolefin foam
3: stiffening layer made of a non-woven
4: skin layer or binder made of a thermoplastic non-woven or grid
5: needle punched composite comprising a preselected airflow resistance
6: additional facecloth
7: multi-layer skin structure
8: core layer
9: foam material
10: fibrous material
11: twin-shell lightweight acoustic trim part
A: acoustic performance of a trim part according to the invention
B: acoustic class 3 requirements

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

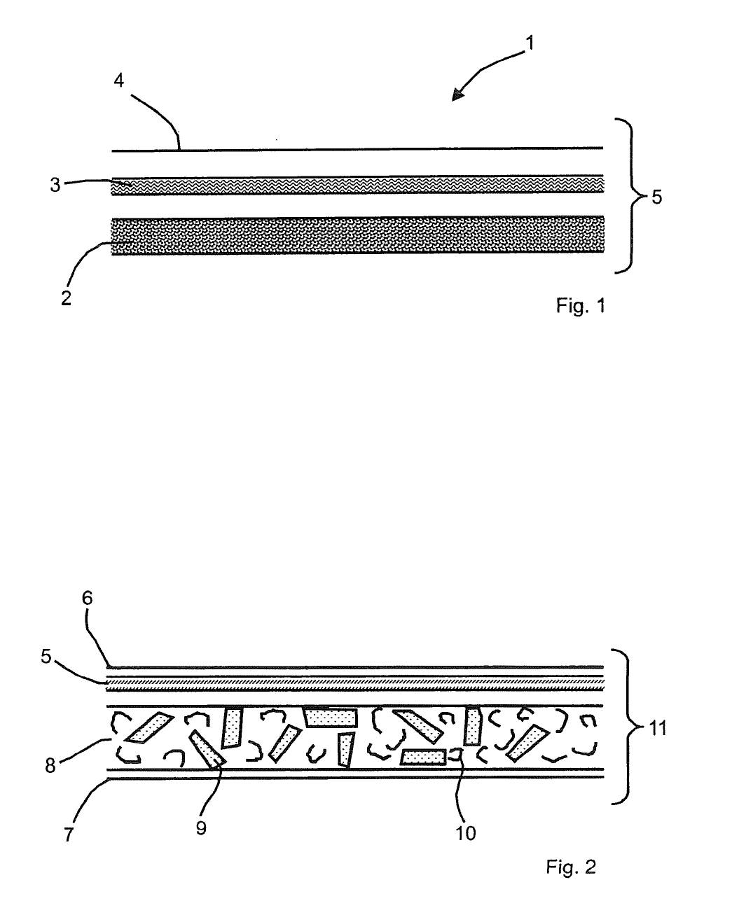

The composite (5) according to the invention and schematically shown in FIG. 1 comprises on its front side, i.e. the passenger compartment side, a skin layer (4), preferably a binder layer made of a thermoplastic non-woven or grid. A stiffening layer (3) is arranged between this skin layer (4) and a soft layer (2). The stiffening layer is made of a non-woven preferably comprising polypropylene and glass fibres and/or copolyester fibres and/or bicomponent fibres, while the soft layer (2) on the rear side consists of closed celled polyolefin foam. These three layers (2, 3, and 4) are needle-punched together in order to set a desired airflow resistance R in the range of 200 Nsm″3 to 5000 Nsm″3. The thickness of this composite (5) approximately varies between 0.5 and 6 mm after the forming process. The skin layer (4) preferably comprises 25 g/mm² of polypropylene SMMS fibre material. The stiffening layer (3) preferably comprises 150 to 250 g/m2 of a non-woven material, and in particular 40% of polypropylene fibres and 60% of glass fibres. In a preferred embodiment, the soft layer (2) has a density of 30 to 90 kg/m3.

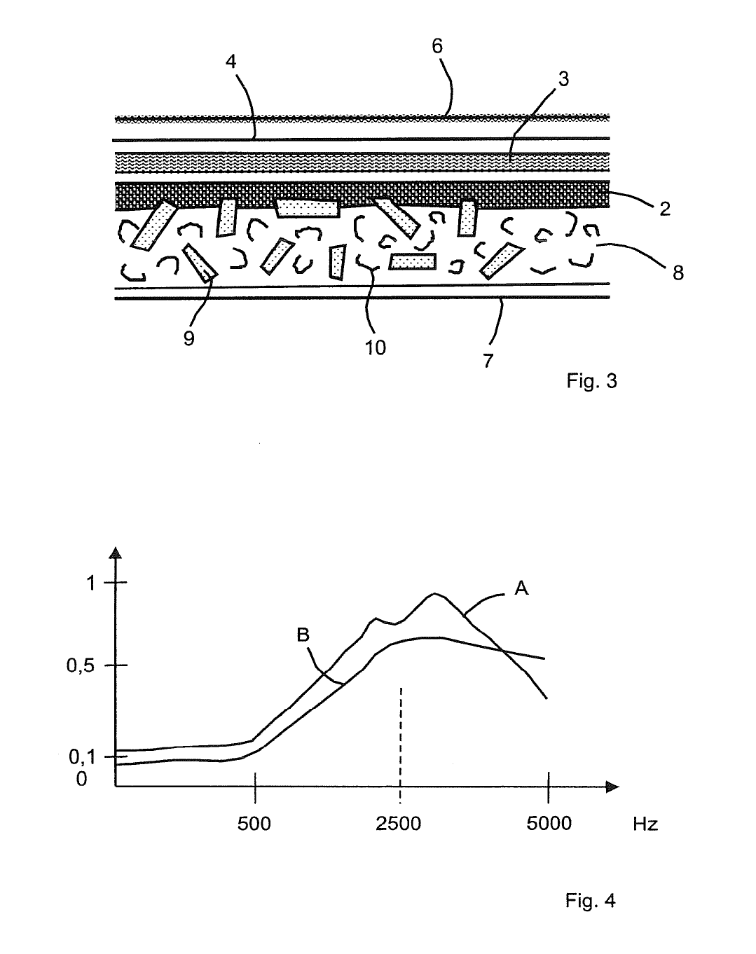

FIG. 2 and FIG. 3 show a schematic cross-sectional view of the twin-shell lightweight acoustic trim part (11), in particular a self-supporting vehicle's headliner or a rear parcel shelf in accordance with the invention. This trim part (11) comprises the above thermoplastic acoustically effective structural composite (5) with at least three layers (2, 3, and 4). In accordance with the invention this composite (5) comprises on its rear side a soft layer (2) consisting of an approximately 1-6 mm thick polyolefin foam and is needle-punched in order to set a desired air flow resistance R in the range of 200 Nsm″3 to 5000 Nsm″3. In a preferred embodiment this twin-shell lightweight acoustic trim part (11) further comprises an air-permeable cover layer (6), in particular a facecloth, a malifleece or a foamed textile on its front or visible face. In order to achieve good mechanical properties this twin-shell lightweight acoustic trim part (11) further comprises a multi-layer skin structure (7) on its back face. This multi-layer skin structure (7) comprises in a preferred embodiment a 40 g/m2 film made of PE, a 50 g/m2 glass veil, a 35 g/m2 film made of PE and a 20 μm film of PA6-6. In accordance with the invention, the trim part (11) comprises a core layer (8) between the thermoplastic bonded and acoustically effective structural composite (5) and the multi-layer skin structure (7). This core layer (8) comprises elastomeric foam material (9) and/or fibre-felt material (10). In a preferred embodiment, the elastomeric material (9) is in the form of foam sticks or chips having a side length of about 2-15 mm. In accordance with one aspect of the invention, the composite layer (5) allows to compensate for the uneven surface of the inhomogeneous core layer (8) and to achieve a smooth and soft touch feeling, i.e. a pleasant haptic effect. In particular the core layer (8) has a weight of 100 g/m2 to 450 g/m2 and contains approx. 50 parts of an elastomeric foam sticks or chips, approx. 20 parts of glass fibres, approx. 10 parts of polypropylene fibres material, approx. 20 parts bicomponent polyester fibres and preferably comprises additional 15% of recycled elastic foam material.

The acoustic performance of present invention becomes evident from the measurements shown in FIG. 4. Graph B represents the frequency dependent values given for the class 3 requirements for the acoustic absorption performance of trim parts. The graph A represents measured absorption values of a trim part according to the invention.

Obviously, many modifications and variations of present invention may be made in the light of the above teaching. In particular, it is to be understood that the stiffening layer may comprise fibres that preferably are arranged in a perpendicular direction to the layer's surface. As well the needling density, the needle's gauge (size), the needle's shape, the penetration depth, the local needling distribution may be varied by the man skilled in the art. Of course, it is within the scope of common practice to locally vary the thickness of the trim part and/or to use other foam materials, such as melamin or PUR foams and preselecting the resilience force of the core layer or its foam sticks or chips.

In a particular embodiment, an acoustically effective thermoplastic structural composite (5) comprises at least three layers (2, 3, 4), which composite is suitable for manufacturing a self-supporting twin-shell lightweight acoustic trim part, whereby this composite (5) comprises on its front side a skin layer (4), preferably a binder layer made of a thermoplastic non-woven or grid, a stiffening layer (3) made of a non-woven, preferably comprising polypropylene and glass fibres and/or copolyester fibres and/or bicomponent fibres, and on its rear side a soft layer (2) consisting of a foam, preferably a polyolefin foam, which layers are needle-punched together in order to set a desired air flow resistance R in the range of 200 Nsm⁻³ to 5000 Nsm⁻³.

The composite can have a skin layer (4) comprising approx. 25 g/mm² of polypropylene SMMS fibres material.

Furthermore, the composite can have a stiffening layer (3) comprising 150-250 g/m^{w} of a non-woven material, preferably comprising approx. 40% of polypropylene fibres and approx 60% of glass fibres.

The soft layer (2) of the acoustically effective thermoplastic composite can have a thickness of 0.5-6 mm. It can have a density of 30 to 90 kg/m³.

An embodiment of a twin-shell lightweight acoustic trim part (11), in particular a self-supporting vehicle's headliner or a rear parcel shelf, comprises an acoustically effective thermoplastic structural composite (5) comprising at least three layers (2, 3, 4), which composite is suitable for manufacturing a self-supporting twin-shell lightweight acoustic trim part, whereby this composite (5) comprises on its front side a skin layer (4), preferably a binder layer made of a thermoplastic non-woven or grid, a stiffening layer (3) made of a non-woven, preferably comprising polypropylene and glass fibres and/or copolyester fibres and/or bicomponent fibres, and on its rear side a soft layer (2) consisting of a foam, preferably a polyolefin foam, which layers are needle-punched together in order to set a desired air flow resistance R in the range of 200 Nsm⁻³ to 5000 Nsm⁻³.

The trim part (11) can further comprise an air-permeable cover layer (6), in particular a facecloth or a malifleece or a needle felt or a back foamed textile on its front or visible side.

The trim part (11) may further comprise a multi-layer skin structure (7) on its back side. This multi-layer skin structure (7) can comprise an approx. 40 g/m² film made of PE, an approx. 50 g/m² glass veil, an approx. 35 g/m² film made of PE and an approx. 20 μm film of PA6-6.

The trim part (11) can further comprise a core layer (8) between the acoustically effective thermoplastic structural composite (5) and the multi-layer skin structure (7), which core layer (8) comprises an elastomeric and resilient foam material (9) and/or fibres material (10).

This core layer (8) can have a weight of approx. 100 g/m² to 450 g/m² and preferably contains approx. 50 parts of elastomeric and resilient foam material (9) in the shape of sticks or chips, approx. 20 parts of glass fibres material, approx. 10 parts of polypropylene fibres material, approx. 20 parts bicomponent polyester fibres and preferably comprises additional 15% of recycled elastic foam material.

In this twin-shell lightweight acoustic trim part (11), the acoustically effective thermoplastic structural composite (5) compensate for the unevenness of the inhomogeneous core layer (8), in order to achieve a desired haptic property, i.e. to provide for a smooth and soft touch feeling.

The twin-shell lightweight acoustic trip part (11) may be manufactured by a vacuum forming process.

1-13. (canceled)

14. A twin-shell acoustic trim part, comprising:
a needle-punched thermoplastic structural composite with a skin layer at a front side of said structural composite, a soft foam layer at a rear side of said structural composite, and a stiffening layer between said skin layer and said soft layer;
said skin layer, said soft foam layer, and said stiffening layer being needle punched together such that said structural composite comprises an airflow resistance R value between 200 Nsm⁻³ and 5000 Nsm⁻³;
said needle-punched structural composite disposed at a front side of said acoustic trim part;
a multi-layer skin structure at a back side of said acoustic trim part, said multi-layer skin structure being substantially impermeable to air flow; and
said structural composite and said multi-layer skin structure being vacuum formed together.

15. The acoustic trim part as in claim 14, further comprising an elastomeric core layer between said structural composite and said multi-layer skin structure.

16. The acoustic trim part as in claim 15, wherein said core layer comprises one of a resilient foam material or a fiber-felt material.

17. The acoustic trim part as in claim 15, wherein said core layer comprises a blend of foam sticks or chips and a fiber material.

18. The acoustic trim part as in claim 15, wherein said core layer comprises a weight of between about 100 g/m² and about 450 g/m².

19. The acoustic trim part as in claim 17, wherein at least a portion of said foam sticks or chips are from recycled foam material.

20. The acoustic trim part as in claim 17, wherein said foam sticks or chips have a length of between about 2 mm and 15 mm.

21. The acoustic trim part as in claim 15, wherein said core layer comprises about 50 parts of resilient foam sticks or chips, about 20 parts of glass fiber material, about 10 parts of polypropylene fibers, and about 20 parts of bicomponent polyester fibers.

22. The acoustic trim part as in claim 21, wherein at least about 15% of said resilient foam sticks or chips is recycled foam material.

23. The acoustic trim part as in claim 14, wherein said skin layer of said structural composite comprises a binder layer of thermoplastic nonwoven or grid material.

24. The acoustic trim part as in claim 14, wherein said stiffening layer of said structural composite comprises one of: a non-woven of polypropylene (PP) and glass fibers; a nonwoven of co-polyesters; a non-woven of bicomponent fibers; a non-woven of 60% glass fibers and 40% reinforced PP; or a non-woven with 45% PP and 55% glass fibers.

25. The acoustic trim part as in claim 14, wherein said soft layer of said structural composite comprises a closed cell polyolefin foam with a density of between 30 and 90 kg/m³ and a thickness of between 1 and 6 mm.

26. The acoustic trim part as in claim 14, wherein said structural composite has a final thickness of between 0.5 and 6 mm.

27. The acoustic trim part as in claim 14, wherein said multi-layer skin comprises one of: a 40 g/m² PE film; a 50 g/m² glass veil; a 35 g/m² PE film; or a 20 um PA6-6 film.

28. The acoustic trim part as in claim 14, further comprising an air-permeable cover layer attached to a front side of said acoustic trim part.
